(19) United States
(12) Patent Application Publication
(10) Pub. No.: US 2022/0247347 A1
(43) Pub. Date: Aug. 4, 2022

(54) DRONE SYSTEMS FOR CLEANING SOLAR PANELS AND METHODS OF USING THE SAME

(71) Applicant: Michael Gavrilov, Fresno, CA (US)

(72) Inventor: Michael Gavrilov, Fresno, CA (US)

(21) Appl. No.: 17/705,218

(22) Filed: Mar. 25, 2022

Related U.S. Application Data
(63) Continuation-in-part of application No. 17/529,286, filed on Nov. 18, 2021.
Application No. 17/529,286 is a continuation-in-part of application No. 16/520,827, filed on Jul. 24, 2019, now abandoned.
(60) Provisional application No. 63/238,785, filed on Aug. 31, 2021.
(60) Provisional application No. 62/868,909, filed on Jun. 29, 2019.
(60) Provisional application No. 63/238,785, filed on Aug. 31, 2021.

(51) Int. Cl. H02S 40/10; B08B 13/00; B08B 3/02; B08B 5/02; B64C 39/02; B64D 1/18; B64D 47/08; B64D 27/24; B64D 9/00; G05D 1/10; G05D 1/00

(52) U.S. Cl. CPC H02S 40/10; B64C 2201/12; B08B 3/024; B08B 5/02; B64C 39/024; B64D 1/18; B64D 47/08; B64D 27/24; B64C 39/022; B64D 9/00; G05D 1/101; G05D 1/0038; B64C 2201/146; B64C 2201/027; B64C 2201/042; B08B 13/00

(57) ABSTRACT

The present invention provides an unmanned aerial vehicle (“UAV”) operations system for cleaning one or more designated surfaces such as a solar panel installed on a roof, or the surface of a window, wall, billboard, scoreboard, etc., which may be too high or too far away from a position on the ground which is easily and safely accessible by a person. For solar panels, such cleaning is not only for aesthetic purposes, but must be performed regularly in order to keep the solar panel functioning at peak performance. The system may also include a ground companion vehicle such as an ATV, golf cart, or the like, which can follow an approximation of the UAV's flight path and provide cleaning media and power to the UAV via a tether, allowing the UAV to clean a large number of surfaces before returning to refill or recharge.

### FIELD OF THE INVENTION

The present invention relates generally to unmanned aerial vehicles for use in carrying out tasks, and more specifically to using piloted or pre-programmed drones for safely and efficiently cleaning solar panels.

### BACKGROUND OF THE INVENTION

The statements in this section merely provide background information related to the present disclosure and may not constitute prior art.

Concerns over climate change and air quality have brought the field of renewable energy into the forefront of both scientific endeavor and political discourse. Renewable energy technologies, are clean sources of energy that have a lower environmental impact than conventional fossil fuel and nuclear energy technologies. An important and increasingly commercially available type of renewable energy technology is solar technology, which typically involves solar panels used to absorb the electromagnetic energy provided by photons released by the sun. Because of the need for a solar panel to have unobstructed sunlight in order to properly function, solar panels have been installed on the roofs of countless homes and business around the world, as well as on standalone structures over parking lots, and in long and numerous rows at solar farms. These installations represent significant investments based on the expectation of years of continued energy production from the solar panels. However, in order for a solar panel to produce energy at peak efficiency, the panel's surface must be clear of dirt and debris which can block the sun's photons from being absorbed by the panel for conversion into electricity. This requires regular cleaning of the surface of the panel.

Conventional methods for cleaning the surfaces of solar panels, whether the panels are residential or commercial, have involved a person climbing up onto the roof of the home or commercial structure with some combination of a hose, bucket, towels, brushes, and squeegees, and washing the panels by hand. The process may involve significant time in preparation for cleaning the panels, such as obtaining and setting up a tall ladder, and potentially having to adjust the ladder multiple times in order to access all of the panels. Also, it may require connecting to a remote water source, requiring the use of a long, heavy hose. Time and effort for stowing such equipment after the panels have been cleaned may be significant as well. This process must then be repeated on a regular basis for years on end. This method is inefficient and costly in terms of labor, especially for a cleaning company which has multiple cleaning jobs each day. The process also represents a significant safety risk for the person cleaning the panels, presenting multiple opportunities for the cleaner to make a misstep and fall off of the roof or structure, or fall from the ladder used to access the panels. Again, for a commercial cleaner working on multiple structures every day, this risk is constant.

Therefore, what is needed is an improved system and method for cleaning solar panels which both improves efficiency and decreases risk of injury.

### SUMMARY OF THE INVENTION

The present invention provides an unmanned aerial vehicle operations system for cleaning one or more designated surfaces. The designated surface may be a solar panel installed on a roof, above a parking structure, or in long rows in a solar farm. The designated surface may alternatively be a surface of a window, a wall, a roof, an eve, a gutter, a billboard, a scoreboard, a screen, a fence, or another similar surface. The designated surface may be too high or too far away from a position on the ground which is easily and safely accessible by a person. The unmanned aerial vehicle (“UAV”) may be a rotor craft such as a multicopter (e.g., a quadcopter), or other appropriate vehicles (i.e., a drone), operable to easily fly up or over to the position of the designated surface and to apply a cleaning media in order to remove dirt and debris from the surface. In the case of a solar panel, such cleaning is not only for aesthetic purposes, but must be performed regularly in order to keep the solar panel functioning at peak performance. The cleaning media may be pumped at high pressure from a tank and applied to the surface via a distribution device which may be operable to direct a spray of the cleaning media at the surface. The tank may be onboard the UAV such that the UAV may be free to fly in the most direct and efficient flight path and cleaning path. The tank may alternatively be located on a ground companion vehicle such as an ATV, golf cart, or the like, which can follow an approximation of the UAV's flight path on the ground and provide a greater volume of cleaning media than the UAV would otherwise be able to carry, allowing the UAV to clean a greater number of surfaces before returning to refill or refuel. The system may thus be operable to safely and efficiently reach and clean one or more designated surfaces in locations which are dangerous, difficult, and time consuming for a human to clean.

In other embodiments of the system, the tank may be located at a home platform or other ground station having a substantially flat surface of sufficient size for the UAV to safely land upon and be secured to (e.g., via clips, cords, ropes, or other similar securing device, during transportation to the site of the designated surface). In embodiments wherein the tank is located on a ground companion vehicle or at a home platform, the cleaning media, as well as electrical power or fuel suitable to power the UAV (e.g., gasoline, natural gas, air pressure, steam, or other similar power source), may be fed to the drone via a tether. The tether may comprise at least one transfer line such as a hose or other watertight line to transfer the cleaning media to the UAV. The tether may further include a power line for powering the UAV, such as a hose for transferring fuel, air, or steam, or an electrical lead for providing electrical power. In other embodiments, the UAV may have an onboard tank and may make return trips to the companion vehicle, home platform, or other ground station in order to replenish the cleaning media in the tank and to refuel or recharge before taking off again to clean further surfaces.

The system may include the following major components: a UAV having a plurality of lift devices, a distribution device for directing cleaning media at a designated surface, at least one sensor for determining the position of the UAV and adjacent objects, and viewing the area adjacent to the distribution device, and an onboard controller having a central processor, a memory, and a communications device; a tank for holding a volume of the cleaning media and a pump for pumping the cleaning media to the distribution device, the tank being located either onboard the UAV, or connected to the UAV via a tether and located on the ground. The system may also optionally include a remote controller operated by a UAV pilot (e.g., a UAV pilot) for remotely controlling the UAV and the distribution device, a transport vehicle for transporting the UAV and a home platform to a location adjacent to the designated surface to be cleaned; and/or a ground companion vehicle tethered to the UAV for providing a greatly increased volume of cleaning media when there is a large area or a large number of surfaces to be cleaned.

The UAV may have an onboard computing device, hereinafter referred to as a controller or onboard controller, and may be capable of vertically taking off and landing, hovering and precisely maneuvering near walls, roofs, pillars, and other structures. In order to clean a designated surface, the aerial vehicle includes an articulable cleaning media distribution device such as a nozzle or shower head, and the distribution device may be adjustable and articulate in multiple way to regulate the direction and flow of a spray of the cleaning media onto the surface. In some embodiments, the cleaning media may comprise at least one of water, steam, air, an aqueous solution including a soap, an aqueous solution including a biodegradable cleaner, and a combination thereof. The biodegradable cleaner may be organically disposable and safe for surrounding flora and fauna.

The flow of cleaning media may be regulated by an adjustable valve and the direction of the spray of cleaning media may be regulated via an adjustable swivel mount, the valve and swivel mount being adjusted via a solenoid or the like which is controlled by the controller. The distribution device may be detachable and replaceable, and the nozzle or shower head may thus be replaced with a brush, pad, cloth, squeegee, or the like, or some combination of one or more such devices. The system may be operable to switch between a variety of cleaning techniques that may depend on the structure of the distribution device and any other devices connected thereto. For example, the UAV may have a distribution device comprising a swivel mount based structure, spray nozzle, and a brushing device so that it may alternate from a swiveling spray technique, to a brushing or wiping technique that utilizes a flow of the cleaning media fed in from the tank to coat the brush. The distribution device may be connected to the cleaning media source (e.g. an onboard tank) via a delivery channel, and the system may include a pump operable to pressurize the cleaning media in the tank or pump the cleaning media directly into the delivery channel and out to the distribution device. The functions of the distribution device may be controlled by the controller and determined by a preprogrammed set of instructions stored in a memory of the controller, or the position of the distribution device may be determined by a UAV pilot inputting instructions into a remote controller, the remote controller transmitting the instructions to a communications device (e.g., a transceiver) on the UAV. The speed and activation of the pump may be controlled by the onboard controller or by the UAV pilot via the remote controller. For example, the pump may be autonomous and operate based on a pressure reading in the tank as determined by a pressure sensor in electronic communication with the onboard controller.

The UAV may further be operable to proceed through a cleaning session wherein the UAV applies a cleaning media to the designated surface, and a rinsing session wherein the UAV applies a rinsing media to the designated surface, without landing. The UAV may comprise a first onboard tank for holding the cleaning media (e.g., an aqueous soap), and a second onboard tank for holding a rinsing media (e.g., water or spot-free rinse such as an aqueous solution containing deionized water and a non-ionic surfactant). The UAV may further comprise a valve (e.g., a Y valve) in communication with a pump of the first tank, a pump of the second tank, and the distribution device, such that the valve is operable to switch the media being applied through the distribution device from the cleaning media to the rinsing media, and back to the cleaning media. In embodiments which include a tether rather than an onboard tank, the tether may comprise a first line for delivering cleaning media to the UAV and a second line for delivering rinsing media to the UAV, the Y valve being able to switch from the first line to the second line, and back again.

The UAV may also include a sensor suite operable to detect obstacles (e.g. trees, branches, animals, people, etc.) in the flight path of the UAV, as well as the designated surface(s) to be cleaned. The sensor suite may include one or more sensors, the sensors including at least one of: a digital camera for capturing images and live video, a scanner for scanning said surface or reading a code thereon, a motion sensor for determining a position of said surface relative to the UAV, a gyroscope sensor for determining the rate of rotation, angular velocity, and or tilt; an accelerometer for determining linear movement along an axis, a magnetometer to indicate the direction of the magnetic field to verify heading, a light detection and ranging sensor (LiDAR) and a GPS or similar sensor operable to determine the exact location of the UAV. For example, the gyroscope may be used to determine the optimal amount of tilting required to most efficiently cover the surface in cleaning media and/or minimize resource consumption (i.e. cleaning media, battery, etc.). As another example, the accelerometer may be used determine the effect of external forces (e.g. wind) and utilize the UAV's lift devices to either neutralize the effect of the force or utilize it to minimize flight power consumption. As another example, the magnetometer may be used in the instance where the device momentarily fails or is disoriented (e.g., collision or software malfunction) to verify the direction the UAV is heading on recovery. As another example, a LiDAR sensor may be utilized to determine the distance between the UAV and other objects such as obstacles or the surfaces to be cleaned. The camera may be any camera operable to obtain a digital image of an area adjacent to the UAV.

In some embodiments the controller may further comprise stereo mapping software operable to receive and process at least two images captured to generate at least one stereoscopic image and utilize the image to approximate the size, shape, and position of nearby objects, effectively mapping out the workspace (i.e., generate positioning data). In such embodiments, the UAV may be operable to capture a plurality of images via one camera or utilize a plurality of cameras simultaneously capturing images to generate a stereoscopic image of a given workspace. The mapped-out workspace may comprise a field of view (FOV) of up to 360 degrees and include approximations of the position of every object within a predetermined range. The predetermined range may be the optimal distance to optimize power or cleaning efficiency or may simply be part of hardware limitations. For example, the UAV may have a total of 4 pairs of cameras uniformly distributed across the UAV's chassis to approximate the position of all items within the 360 degrees FOV and within 10 meters of the UAV.

In some embodiments, the controller may include matrix code analysis software operable to detect via the camera(s) and recognize a surface marker comprising a code printed on or adjacent to the designated surface (e.g., a bar code, a QR code, or the like), the code either providing data regarding the shape, location, and/or orientation of the designated surface, or being associated with such data already stored in the memory of the onboard controller. The controller and code may thus allow the UAV to determine the exact location, size and shape of the surface to be cleaned.

The position sensor may be any sensor operable to detect a position and shape of objects adjacent to the UAV. The position sensor may thus allow the UAV to determine, in conjunction with the GPS sensor and/or camera(s), the exact location and location and shape of the surface to be cleaned.

In some embodiments, the controller may then be operable to utilize such data, along with data regarding the dimensions of a spray of cleaning media provided by the distribution device (or a size of the cleaning surface of a non-spraying distribution device) in order to determine positioning data regarding a surface cleaning path for that particular designated surface, and record such positioning data in the memory for subsequent cleaning of that designated surface. In other embodiments, the controller may be operable to record in the memory and recall GPS coordinates of a cleaning path flown by the UAV under instruction from a UAV pilot via the remote controller. The recorded path data (i.e. preprogrammed flight path data) may comprise the GPS coordinates of several steps of the flight path (e.g. lift off, navigation to surface, spray path navigation, etc.) and may include a time stamp of every single coordinate. The prerecorded path data may also be uploaded to a remote server or other devices in the system (i.e., other UAVs or the mobile unit) such that other UAVs with access to the data are operable to follow the same path seamlessly. In either such embodiments, on subsequent visits a UAV may already have a predetermined and preprogrammed flight path, with the controller being operable to automatically navigate the UAV through the surface cleaning path for subsequent cleaning(s) of the surface without the need for input from a UAV pilot. The memory may have the capacity to store a plurality of pre-programmed flight paths, and the controller may be operable to automatically navigate the UAV through such pre-programmed flight paths, for a plurality of different surfaces at a single location, and for a plurality of surfaces at a plurality of different locations. In some embodiments, the UAV may be operable to load recorded path data directly into the controllers memory from other devices such as a cloud server, another UAV, or a companion vehicle.

In such embodiments, the companion ground vehicle may comprise a companion controller in communication with the onboard controller, or the companion controller may be located on the ground companion vehicle while still in wired (via the tether) or wireless (via the communications device) electronic communication with sensor suite the UAV, the onboard controller, propulsion system, and/or distribution device. In some embodiments, the companion controller may include a display for providing a driver of the companion ground vehicle with a visual representation of the pre-programmed flight path and the GPS location of the companion ground vehicle and the UAV. In some embodiments the display comprises simple map interface where pertinent objects (e.g. UAV, flight path, homes, solar panel surface, trees, etc.) are represented by geometric shapes on the display and emphasized (e.g. colored, highlighted, flashing, etc.) accordingly. In other embodiment the display may comprise the camera feed of one or more cameras on the UAV and may also display augmentations to help pilot the UAV. The driver may thus drive the companion ground vehicle in an approximation of the flight path of the UAV, preventing the UAV from running out of room to maneuver due to a fully extended tether. In yet other embodiments, the companion ground vehicle may be a self-driving vehicle utilizing a sensor suite to navigate, and may be operable to automatically follow an approximation of the pre-programmed flight path of the UAV, or follow along as the UAV is flown by a UAV pilot, who may be sitting in the companion ground vehicle.

In embodiments wherein the UAV is not tethered, the controller may be further operable to determine a GPS position of a home platform. The home platform may provide a home location for the UAV, data transfer connections, power connections, a source for refilling the cleaning media in the tank of the UAV, and a location for the UAV to be secured (e.g., strapped down) during transportation in a transport vehicle. The home platform may be associated with a transport vehicle (e.g., mounted to the vehicle on rails which allow the platform to be pulled out of an open door or hatch of the transport vehicle), or located on the ground near the designated surface (e.g., on the ground next to the building, adjacent to the closest available water or electrical outlet, or the end of a hose or extension cord connected thereto). In some embodiments, the home platform may extend from at least one of an open door or doors (e.g., a side door or doors, a rear door or doors, or a front door), an open hatch (e.g., a rear hatch, side hatch, or roof hatch) or other similar opening of the transport vehicle. In some embodiments, a reserve tank for holding cleaning media and having a refilling device, and a power source for refueling the UAV or charging a battery of the UAV and having a charging device, may be installed anywhere in or on the transport vehicle (e.g., in a cargo bay, a cargo bed, in a wall, on a ceiling, or on a roof of the transport vehicle).

The home platform may include a docking mechanism operable to receive the UAV, hold the UAV in place on the upper surface of the platform, and line the up the refilling device and the charging device of the home platform for easy and/or automatic connection with a refilling receiver and a charging receiver of the UAV (e.g., docking of the UAV at the home platform automatically connects the refilling device with the refilling receiver and connects the charging device with the charging receiver). The refilling device and the refilling receiver may comprise any connectors operable to provide a watertight connection between the reserve tank of the home platform and the tank of the UAV. In some embodiments, the refilling device may comprise, e.g., a quick-connect barbed male hose connector having a shape complementary to a shape of the refilling receiver, which may comprise, e.g., and a quick-connect female hose connector receiver. In other embodiments, the refilling device may comprise the female end and the refilling receiver may comprise the male end. The charging device and the charging receiver may comprise any connectors operable to provide an electrical connection between a power source of the home platform and a battery and/or controller of the UAV. In some embodiments, the charging device may comprise a multi-prong male electrical connector (e.g., a three-prong or two-prong plug) and the charging receiver may comprise a multi-hole female connector (e.g., a three-prong or two-prong receiver similar to a wall outlet). In other embodiments, the charging device may comprise the female connector and the charging receiver may comprise the male end.

The docking mechanism may comprise one or more clamping devices arranged on the upper surface of the home platform, a shape and placement of the one or more clamping members corresponding with a shape and placement of one or more lower support members of the UAV (e.g., landing rails, feet, or the like). The home platform may comprise one or more docking sensors (e.g., a pressure switch, a position sensor, a motion sensor, another similar sensor, and a combination thereof) operable to detect when the lower support members of the UAV are located adjacent to the one or more clamping members and thus the UAV is in position for docking, and send a docking signal to a home platform controller. The docking mechanism may then be operable to move (e.g., via an electric motor, a solenoid, a pneumatic mechanism, or the like) from an open position (e.g., wherein the one or more clamping members are not engaged with the one or more lower support members) to a docked position (e.g., wherein the one or more clamping members is in a position which holds the one or more lower support members in place on the upper surface of the home platform). The one or more sensors, the clamping mechanism, the charging device, and a pump of the reserve tank may each be in electronic communication with the home platform controller, the home platform controller being operable to receive the docking signal from the one or more docking sensors and subsequently: 1) cause the docking mechanism to move from the open position to the docked position, securing the UAV in place on the home platform; 2) activate the pump of the reserve tank to move cleaning media from the reserve tank to the tank onboard the UAV and shut the pump off when the onboard tank is substantially full or the reserve tank is substantially empty; and 3) causing power source to charge the battery of the UAV the until the battery is substantially charged or the power source is substantially out of power. The controller may further be operable to automatically cause the docking mechanism to move back to the open position upon the at least one of the onboard tank becoming substantially full with cleaning media and the battery obtaining a full charge.

The home platform may further comprise a platform marker on the upper surface, the platform marker comprising a code readable by the one or more sensors of the UAV. The platform marker may comprise a code (e.g., a QR code, a bar code, an alpha-numeric code, and the like, or a combination thereof) which may be scanned by the one or more sensors and deciphered by the onboard controller, the code providing information regarding a position and orientation of the home platform such that the UAV may determine exactly where to land in order to dock with the home platform. In some embodiments, the platform marker may comprise a QR code having identification information (identifying the home platform to the controller) and orientation information (e.g., the platform marker may always be located in a particular corner of the upper surface and may always be oriented such that a mark of the QR code is in a corner of the platform marker furthest from a center of the upper platform). The controller may thus be able to determine exactly how to orient the UAV (e.g., how many degrees to rotate left or right) and how far to travel (e.g., exactly 12 inches away from the corner of the platform marker) in order to sufficiently align the lower support members with the docking mechanism such that the UAV may automatically dock with the home platform.

Thus, when the UAV requires refilling of the onboard tank or charging of the battery, the UAV may be operable to autonomously locate, orient with, and alight on the home platform, and the home platform may then be operable to autonomously secure the UAV to the upper surface via the docking mechanism, connecting the refilling device and the charging device with the refilling receiver and charging receiver, respectively, refill the onboard tank, charge the battery, and then open the docking mechanism, allowing the UAV to resume cleaning a designated surface.

The home platform may include leveling means, the leveling means allowing a user to adjust the position of the home platform such that the upper surface thereof is level (e.g., a plane of the upper surface is substantially perpendicular to vertical). In some embodiments the leveling means may comprise a plurality of extendable legs, each of the plurality of extendable legs comprising means for extending a length of that leg. In some embodiments, each of the extendable legs may comprise a first and second member slidably engaged with each other and lockable with respect to each other (e.g., a first cylindrical member slidably nested within a second cylindrical member, the first cylindrical member comprising a resilient depressible tab and the second cylindrical member comprising a series of slots along a length thereof in which the depressible tab may be inserted). Each extendable leg of the plurality of extendable legs may thus be independently adjusted in length until the home platform is level. In some embodiments, the home platform may comprise at least one leveling bubble such as those used in a level tool for construction projects. In some embodiments, the plurality of extendable legs may each comprise an automated extending device (e.g., a pneumatic cylinder) controllable by the platform controller, the platform controller being operable to automatically level the home platform via the plurality of extendable legs. In embodiments wherein the home platform is integral with a transport vehicle the plurality of extendable legs may each be connected to a support structure of the vehicle (e.g., connected to a scaffolding mounted to one or more rails for extending the home platform out of the vehicle). In embodiments wherein the home platform is not integral with a transport vehicle, the plurality of extendable legs may each have a foot (e.g., a pad) at a lower end thereof for engaging the ground.

The onboard controller may comprise a navigational software program, the software program being operable to receive positional data from the senor(s) of the UAV (e.g., locational data from a GPS device, accelerometer data, and data regarding adjacent obstacles from images captured via digital camera and/or motion sensor) and calculate a flight path from a first position (e.g., a position of the home platform) to a second position (e.g., a position of a designated surface). The navigational software program may further be operable to receive positional data regarding a designated surface from at least one of the sensor(s), the memory, and a code printed on a marker on the designated surface, and from such data calculate a surface cleaning path which allows a spray of cleaning media from the distribution device, taking into account the shape and distance of the spray, to efficiently cover the entire designated surface with the spray. For example, if the surface to be cleaned is known to have a rectangular shape with a height of 5.4 ft and width of 3.25 ft, the UAV may calculate the distance at which the spray or spray pattern will have a width of approximately 3.25 ft and maintain that distance as it moves parallel to the height approximately 5.4 ft. The controller may thus be operable to autonomously determine positioning data for an overall flight path of the UAV and navigate the UAV from the home platform to the designated surface, through the surface cleaning path, and back to the home platform (e.g., for refilling/refueling, or for being secured for transport or storage). For example, the UAV may utilize image data to map out the surroundings such that it's able to detect and avoid objects in the flight path, determine the size and orientation of the surface to be cleaned, generate a cleaning path, and return to the base in a similar manner.

In some embodiments, the system may not include the transport vehicle and home platform (e.g., for small residential applications). The home platform may be operable to connect to a water source (e.g., a hose or spigot) for the purpose of filling the reserve tank on the home platform or directly filling the tank onboard the UAV, and may be operable to connect to an electrical power source (e.g., a wall outlet) for the purpose of providing power to the charging device or charging a battery of the home platform.

In some embodiments, at least one of a home platform and a ground companion vehicle may comprise a reserve tank for holding cleaning media and a power source for fueling the UAV or charging the battery of the UAV. In some embodiments, the UAV may be in communication with the reserve tank or the power source, or both, via a tether. In other embodiments, the UAV may be untethered and may need to return the home platform in order to refill its own cleaning media tank and/or refuel or recharge its battery. The home platform may comprise a refilling device for putting the tank of the home platform in fluid communication with the tank of the UAV. In some embodiments, the refilling device may be a hose or other line having a connector operable to connect to a receiver on the UAV, the receiver being in fluid communication with the tank onboard the UAV. The platform may further comprise a charging device for providing electricity to and charging or recharging a battery of the UAV. The charging device may comprise an electrical lead having an electrical connector operable to connect to an electrical receiver on the UAV, the electrical receiver being in electronic communication with at least one of the controller and the battery. The charging device may draw power from a battery of or electrical system of the transport vehicle, a battery or electrical system of the companion ground vehicle, a battery or electrical system of the home platform, or from an electrical outlet of a building or other structure.

The UAV may comprise a plurality of lift devices (e.g., propellers, turbines, jet propulsion nozzles, magnetic levitators, and the like). In some embodiments, the plurality of lift devices may comprise a plurality of propellers. The system may further include a barrier around the path of the propellers for the purpose of preventing contact of the blades with obstacles such as trees, poles, telephone or power lines, gutters, antennas, satellite dishes, and the like to prevent damage or disrupting of the flight path, and to prevent injury to the UAV pilot and/or bystanders.

The onboard controller may receive inputs from the sensor suite and cause the UAV to maneuver a desirable distance from such obstacles and from the surface to be cleaned. For example, the UAV may use a camera and/or proximity sensor to determine the UAV is at the desired distance of approximately 1 meter from the surface to be cleaned then maintain that distance as it cleans the surface. As another example, if an animal or tree branch is detected on the rooftop of a regular job, the UAV may flag it is a hazard, increase the distance from the surface to be cleaned, and adjust the spray path accordingly until the hazard is removed. Such inputs may lead the onboard controller to override any flight path data provided by the UAV pilot via the remote controller. For example, in the event that a hazard has appeared after the UAV pilot has already set the flight/cleaning path, the UAV may automatically adjust the path accordingly and notify the pilot. Such inputs may also be continuously utilized in flight calculations generated by the controller via a feedback loop. When the aerial vehicle is in a desired location, the distribution device may be activated, either automatically if the flight path is pre-programmed, or by instruction from the UAV pilot via the remote controller, the distribution device applying cleaning media to the designated surface (e.g., the upper surface of a solar panel or portions thereof) in the form of a spray or a soaked brush, pad, or towel, depending on the type of distribution device used.

The system may comprise a remote controller operated by a UAV pilot for controlling the flight of the UAV and the activation and adjustment of the distribution device, the remote controller comprising a transceiver for transmitting a signal to the communications device regarding instructions for the UAV, and receiving a signal from the communications device regarding a position, view, and/or condition of the UAV. The remote controller may comprise a plurality of input controls (e.g., one or more joysticks, levers, buttons, and the like) allowing the UAV pilot to input instructions to be transmitted to the UAV, such as flight directions, activation of the distribution device, and a direction and volume of a spray of the cleaning media from the distribution device. The remote controller may also comprise a display (e.g., a graphical display or screen which may be a touchscreen) for displaying information received from the UAV (e.g., GPS position, status of the battery and the level of cleaning media in the tank, video and other data captured by the sensor(s), and the current position and valve status of the distribution device). In some embodiments the display comprises simple map interface where pertinent objects (e.g. UAV, flight path, homes, solar panel surface, trees, etc.) are represented by geometric shapes on the display and emphasized (e.g. colored, highlighted, flashing, etc.) accordingly. In other embodiment the display may comprise the camera feed of one or more cameras on the UAV and may also display augmentations to help pilot the UAV. In some embodiments, the wireless communications device onboard the UAV and the transceiver of the remote controller may each comprise at least one of a Bluetooth device, a WiFi device, a cellular device, an RF device, a microwave device, and another similar device.

A method of using the UAV operations system for cleaning one or more designated surfaces may include the steps of: providing a UAV having a plurality of lift devices, a tank for holding a cleaning media, a pump, a distribution device, at least one position sensor, a communications device for communicating with a remote controller, and an onboard controller for controlling the plurality of lift devices; navigating the UAV to the designated surface; navigating the UAV through a surface cleaning path; and activating the distribution device to apply the cleaning media to the designated surface. In some embodiments, the sensor comprises a digital camera oriented to observe a spray area of the distribution device, and the method may further comprise the step of transmitting a live feed of the digital camera to a display of the remote controller. In such embodiments, the display may be an augmented display with touch screen functionalities, enabling a pilot to view or edit a calculated or recorded path and make adjustments to the flight path. In some embodiments, the distribution device comprises an adjustable nozzle and the controller is operable to adjust a shape and speed of the spray of cleaning media, and a direction of the spray of cleaning media. This can be done in a variety of ways, for example, the shape and speed of the spray provided by the nozzle may be adjusted via at least one of an electric motor and a solenoid operable to twist the nozzle with respect to a support member supporting the nozzle, through a plurality of positions that each correspond with a different spray type. For example, the adjustable nozzle may have a first position operable to provide a wide spray having a relatively slow speed, and a second position operable to provide a spray having a more acute shape and a relatively higher speed as compared to the wide spray. In some embodiments, the direction of the nozzle may be adjusted as well. For example, the UAV may comprise at least one electric motor and solenoid operable to turn at least one rotatable junction of a supporting member supporting the nozzle, adjusting the direction of the spray. In such embodiments, this may enable the distribution device to follow a movement pattern (i.e., side to side, zigzag, etc.) to provide optimal coverage by increasing the coverage of the cleaning media or concentrate it in a particular area. For example, the controller may determine that the surface to be cleaned has a rectangular shape and set the distribution device to follow a side-to-side pattern for optimal coverage of the cleaning media/spray. As another example, the controller may determine the surface(s) to be cleaned comprises a plurality of small circular windows and consequently set the distribution device to a spiral patter for optimal coverage of the cleaning media/spray on each surface. In some embodiments the method may further comprise the step of adjusting the flow rate and the direction of the adjustable nozzle via the remote controller. In some embodiments, the UAV may have a compressor operable to pressurize any cleaning media/liquid stored within such that it may adjust the velocity/flow rate spray. In some embodiments, the adjustable nozzle may adjust the size of the output such that the pressure of the spray at the output is higher or lower, adjusting the velocity/flow rate accordingly. In some embodiments, the UAV may be tethered to and in fluid communication with a reserve tank of a companion ground vehicle, and the method may include the steps of pumping cleaning media from the reserve tank to the UAV and driving the companion ground vehicle in a path approximating the path of the UAV.

In other embodiments, the system may further comprise a home platform having a refilling device and a charging device, and the method may further comprise the steps of navigating the UAV to the home platform and refilling the tank of the UAV. In some embodiments, the method may further comprise the step of navigating the UAV to the home platform and charging a battery of the UAV. In some embodiments, the method may comprise the step of the UAV returning to the home platform upon the occurrence of at least one of: the tank becoming substantially empty of cleaning media (e.g., the tank is at a capacity ranging from about 0% to about 10% of cleaning media, and any capacity or range of capacities therebetween); and the battery of the UAV reaching a minimum threshold of power (e.g., the battery reaches the level of power required for the UAV to navigate back to the home platform, or the battery reaches a predetermined level of power in a range from about 1% to about 10%, and any level of power or range of levels of power therebetween). In some embodiments, the method may further comprise the step of navigating the UAV back from the home platform to the designated surface or to a second designated surface. In some embodiments, the method may further comprise the step of navigating the UAV from the designated surface to a second designated surface and through a second surface cleaning path. In some embodiments, the method may further comprise the step of providing a transport vehicle comprising a home platform operable to extend from an opening (e.g., a door or hatch) in the transport vehicle, a refilling device operable to refill the cleaning media tank onboard the UAV, and a charging device operable to charge a battery of the UAV.

In some embodiments, the onboard controller may comprise a feedback system, operable to utilize data provided by the UAV sensor suite to continuously adjust the propulsion and/or angle of each lift device to maintain at least one flight characteristic. In some embodiments, the feedback system may also continuously adjust aspects of the distribution device (e.g., spray pattern, spray velocity, nozzle orientation, supporting member orientation etc.) in order to more effectively maintain at least one flight characteristic. Such flight characteristics may comprise flight path, cleaning path, spray path, distribution device, position of the distribution device, adjustable nozzle head/position, camera(s) field of view, altitude, tilt angle, distance from surface to be cleaned, size of the surface to be cleaned, or movement pattern. Such characteristics may need to be maintained in order for the UAV to optimize/maximize efficiency in cleaning time and/or the expenditure of at least one resource (e.g., battery power, water, and cleaning media). For example, suppose it's determined that the optimal distance for the UAV to clean a surface with the minimum amount of battery usage is about 1 meter from the surface to be cleaned, the feedback system may continuously make fine-tuned adjustments to the speed of each propeller of the UAV as the distance from the surface begins to deviate from the optimal distance. In addition, the UAV may maintain the optimal distance even as it navigates through a surface cleaning path. The onboard controller may also utilize the feedback system to detect environmental factors (i.e., obstacles, precipitation, wind, and humidity) that may affect such flight characteristics. For example, if the force of the wind is sufficient to cause the drone to drift in one direction, the controller may detect this and utilize the feedback system to instruct the UAV to adjust the tilt angle and/or the speed of one or more propellers to counter the force of the wind and effectively neutralize it. The feedback system may also factor in the effect of internal components, such as propulsion limits, battery level, UAV weight, cleaning media level, and force generated by the distribution of the cleaning media, on the flight characteristics. For example, if the force generated via the activation of the distribution device is sufficient to cause it to drift in a particular direction, the controller may detect this and utilize the feedback system to instruct the UAV to adjust the tilt angle and/or the speed of one or more propellers to counter the force and effectively neutralize it. Such minute changes in the flight characteristic(s) may be continuously monitored by one or more sensors in the sensor suite and provided as input in the feedback system to order to adjust the UAV devices in a manner that helps maintain the flight characteristic(s). For example, the UAV may utilize an accelerometer to detect the drift/minor acceleration being caused by steady wind speeds and even larger drifts/shifting due to periodic gusts of wind. As another example, a gyroscope sensor may be used with the feedback system to enable the UAV to maintain an orientation parallel to that of the surface to be cleaned to achieve optimal coverage of the cleaning media, such that UAV begins to adjust its propulsion system when the angle of the UAV with respect to the surface begins to deviate such that the UAV is no longer substantially parallel. As another example, an optical proximity or LiDAR sensor may be used in conjunction with the feedback system to not only give the approximate distance of the UAV with respect to a surface but also maintain it by adjusting the propulsion system as the distance from the surface begins to deviate in real time.

In some embodiments, the remote controller may contain augmented reality technology, or technology that superimposes a computer-generated image(s) on the feed of at least one camera, that may be utilized in combination with data provided by the UAV sensor suite to provide an ease-of-use piloting method on the remote controller screen. The screen, hereinafter referred to as the augmented display, may be a touchscreen on the remote controller that displays an augmented reality environment wherein one or more augmentations overlays the video feed that enable the pilot to easily monitor and/or control the UAV. Such augmentations provided on the screen may include information regarding the UAV's components or flight characteristics such as flight path, altitude, battery level, cleaning media level, distance from an object, speed, angle, rotation, distribution device head, adjustable nozzle head, and direction of the distribution device. Such augmentations may include methods of adjusting the UAV's components and flight characteristics such as by adjusting dials/knobs, buttons, graphical control features presented on the display screen, or by interacting with remote objects displayed on the video feed, such as solar panels.

Augmentations may comprise a visual emphasis rendered on zones and/or objects in the video feed that the controller or pilot have determined to be important, and may allow the pilot to interact with them to control the UAV in a particular way. The visual emphasis may comprise highlighting, drawing, coloring, shading, bounding or any other practical form of visual emphasis. Zones and objects of interest in the video feed may include any of the following: the projection of a recorded flight path, the projection of a calculated flight path, one or more surfaces to be cleaned, the projection of an application/spray area of cleaning media on a surface, a mobile vehicle, a building, and obstacles. In some embodiments, if the flight path has already been recorded or determined, the projected flight path may be highlighted on the video feed provided on the augmented display, wherein the highlighted portion is adjusted dynamically as the UAV travels through the path. In such embodiments, the flight path may be adjusted via touch input received on the augmented display. For example, the user may simply draw on the augmented display or tap on a designated object to erase, adjust, or create a new flight path for the UAV. In some embodiments the augmented display may be able to display a map of the local area and allow the pilot to create a flight path by drawing the path on the map.

In some embodiments the remote controller may detect a remote surface, determine its distance from the UAV, and highlight the area of the augmented display pertaining to the remote surface wherein the application of cleaning media will reach, hereinafter referred to as the spray area. In such embodiments, the augmented display may allow the user to preview the spray area of various heads of the adjustable nozzle or distribution device. For example, the augmented display may shade areas on the surface covered by a wide nozzle spray in red and a narrow nozzle spray in blue, wherein the overlap is purple. In some embodiments, the augmented display may also preview the effective spray area of a distribution device that's following a movement pattern. For example, if the distribution device is following a side-to-side pattern, the augmented display may preview the effective spray area after one cycle by displaying lines bounding the area on the video feed. In some embodiments the augmented display may preview the entire spray area on a surface for a surface cleaning path, hereinafter referred to as spray path. For example, the UAV may approach a solar panel, retrieve path information from its memory, and direct the augmented display to shade the spray path in blue. In some embodiments, the augmented display may enable the pilot to adjust or create a new spray path by interacting with it on the display. For example, if new solar panels were added to a location since the previous cleaning, the pilot may simply draw on the display where the new panels are visible to add on to the spray path. In some embodiments, when the distribution device heads, the adjustable nozzle head/position, or movement pattern is altered, the UAV controller may automatically adjust the cleaning path and/or movement pattern to generate a spray path that's most similar to the previous spray path. For example, if a cleaning path was previously recorded for a wide spray nozzle and the pilot decides to adjust it to a narrow spray nozzle, the UAV controller may determine a new cleaning path that provides similar or identical coverage as the previous spray path.

In some embodiments, the onboard controller may comprise logic to automatically determine at least one optimal flight characteristic based on at least one other flight characteristic. For example, the controller may identify the size of the surface to be cleaned based on video feed data and determine the UAV should maintain an optimal distance of 2 meters and utilize the wide spray nozzle for optimal coverage. As another example, the UAV may be limited to a single narrow spray nozzle, and may determine that the adjustable nozzle should follow a wide movement pattern for optimal coverage. In such embodiments the UAV may automatically set these flight characteristics or provide them as recommendations on the remote controller for the pilot to approve or override.

In some embodiments, the UAV may further comprise at least one universal connection docking bay for various attachments operable to attach any payload having a complimentary payload interface, hereinafter referred to as the docking bay. The universal connection docking bay may also be operable to create a fluid and/or electrical connection between the payload and other components of the UAV. In such embodiments, the UAV may have a separate onboard battery and/or fluid reservoir(s) in addition to any battery or fluid reservoirs connected via the docking bay. In such embodiments, the electrical connections may comprise any standardized electrical connection including any USB (e.g. A, mini-b, micro-b, C, etc.) or ethernet connection, or may be proprietary connection carrying a signal through at least one wire. In some embodiments the payload may have a wireless communication chip operable to communicate with the UAV and/or a remote controller wirelessly via at least one standardized wireless communication technology (e.g. Bluetooth, Wi-Fi, ZigBee, radio, cellular communication, etc.) or a proprietary wireless communication method. In some embodiments the fluid connection to a UAV may comprise tubing or an opening directed/connected to a valve, compressor, or the distribution device. For example, the UAV may determine that the payload the UAV just attached comprises cleaning media, and a fluid connection between the payload and the distribution device comprises a control valve fluidly connected to the distribution device. In some embodiments UAV may be capable of determining what payloads are appropriate to form a fluid or electrical connection and may further comprise a protection mechanism to prevent damage to the UAV if an improper connection is made by the user. For example, the cleaning media tank, the rinsing media tank, and battery may all have a payload interface and may be operable to connect to any one of the UAV universal payload docking ports.

In such example, the UAV may utilize the onboard controller and/or the sensor suite to determine the payload contents, such as the battery, and create a connection between the payload and other components of the UAV, such as the UAV power distribution circuitry. In such embodiments, one or more of the sensors that comprise the devices sensor suite may be on a docking port or an attached payload. In some embodiments the UAV may have dedicated docking ports for fluid and electrical connections, with a protection mechanism operable of preventing an improper connection from being made. For example, a UAV may have an electrical docking port operable to form an electrical connection for transmitting power and/or data to the UAV via a battery or sensor payload, that further comprises a protection mechanism, such as a moisture locking mechanism that seals the electrical connection circuitry open detecting moisture that may occur if the cleaning media payload is attached.

In some embodiments the tank may have a payload interface and vary in size, shape, and/or contents, providing a UAV with a much more versatile operational range. In such embodiments, the payloads may have any shape practical for the operation, including the shape of a sphere, cube, box, cone, or polyhedron. The docking bay may further comprise at least one securing mechanism operable to enable the UAV or a user to easily connect the payload and lock it in place as needed. The securing mechanism may be any mechanism operable to temporarily affix two solid objects, including one or more of the following: a latch mechanism, a hook, a claw mechanism, an adhesive, a vacuum mechanism, a magnetic attachment mechanism, a scooping mechanism, a box/slot that encloses the item, a clip, or other various fastening/locking mechanisms. In some embodiments the latching mechanism may further comprise an electrical or fluid connection mechanism. In some embodiments UAV's universal connection docking bay may comprise at least one slot or dock with a shape and size complimentary to that of the payload operable to secure the payload by enclosing it. For example, the docking bay may comprise 3 box-shaped slots, each operable to receive at least one box-shaped payload with complimentary dimensions. In some embodiments the UAV may also be utilized for various operations, including parcel delivery, crop dusting, irrigation, fumigation, monitoring or any operation that may require spraying, dusting, or moving a payload. For example, the entire operation of the UAV may comprise irrigating a garden, spraying fertilizer on the garden, and then cleaning the household's solar panels. As another example, the UAV may comprise a package delivery payload that holds one or more packages and transports them towards at least one predetermined location.

In some embodiments the docking bay may be operable to hold one payload with multiple resources, wherein both the UAV and payload may each comprise specialized complimentary ports for data, power, and or/fluid connections with the payload. In such embodiments, the UAV may have a separate onboard battery and/or fluid reservoir(s) in addition to any battery or fluid reservoirs connected via the docking bay. For example, the docking bay may have a singular boxed slot, with dimensions complimentary to the payload, with electrical connections for data and/or power and fluid connections for cleaning media arranged in a predetermined and complimentary manner on both the docking bay and the payload.

The present invention provides improved system for cleaning difficult to reach surfaces such as solar panels in a safe, efficient, and ecofriendly manner (less water is used and the cleaning media may contain all biodegradable substances) by utilizing unmanned aerial vehicles to fly up or over to the surface to be cleaned and spray or otherwise apply the cleaning media to the surface without the need for a person to repeatedly climb up a ladder or onto a roof. These and other features and objects of the invention will be apparent from the description provided herein.

It is an object of the present invention to provide a UAV operations system which provides a safer alternative for cleaning difficult to reach surfaces, reducing the chance of injury from falling from a ladder, roof, or other structure.

It is a further object of the present invention to provide a UAV operations system which improves efficiency and productivity of cleaning difficult to reach surfaces, reducing the human labor and time required, and providing a memory of the flight path required to clean a designated surface such that subsequent cleanings may be pre-programmed and not require active UAV piloting.

It is a further object of the present invention to provide a UAV operations system which improves profitability for businesses providing surface cleaning services, requiring only a single worker UAV operator or pilot for virtually any size job who will be able to complete more jobs each day with a substantially reduced chance of injury.

It is a further object of the present invention to provide a UAV operations system which is eco-friendly, utilizing biodegradable and organically disposable cleaning media, and utilizing distribution devices which use less water than a traditional hose and bucket cleaning system.

It is a further object of the present invention to provide a UAV operations system which is environmentally friendly due to increased use of renewable energy, as the system may be implemented on a regular basis with less worry about injury or effort of cleaning solar panels, increasing the frequency of cleaning and thus the productivity of such solar panels.

The above-described objects, advantages and features of the invention, together with the organization and manner of operation thereof, will become apparent from the following detailed description when taken in conjunction with the accompanying drawings, wherein like elements have like numerals throughout the several drawings described herein. Further benefits and other advantages of the present invention will become readily apparent from the detailed description of the preferred embodiments.

### BRIEF DESCRIPTION OF THE DRAWINGS

FIG. 1 shows a side view of an unmanned aerial vehicle operations system for cleaning one or more designated surfaces, according to an embodiment of the present invention.

FIG. 2 shows a perspective view of an unmanned aerial vehicle for cleaning one or more designated surfaces, according to an embodiment of the present invention.

FIG. 3 shows a perspective view of an unmanned aerial vehicle cleaning one or more designated surfaces following a cleaning path for a designated surface, according to an embodiment of the present invention.

FIGS. 4A and 4B show a side view of an unmanned aerial vehicle operations system cleaning one or more designated surfaces including a home platform, according to an embodiment of the present invention.

FIG. 5 shows a side view of an unmanned aerial vehicle for cleaning one or more designated surfaces, according to an embodiment of the present invention.

FIG. 6 shows a perspective view of an unmanned aerial vehicle operations system for cleaning one or more designated surfaces including a ground companion vehicle, according to an embodiment of the present invention.

FIG. 7A shows a perspective view of an unmanned aerial vehicle operations system cleaning one or more designated surfaces including a transport vehicle, according to an embodiment of the present invention.

FIG. 7B shows a perspective view of an unmanned aerial vehicle operations system cleaning one or more designated surfaces including a transport vehicle, according to an embodiment of the present invention.

FIG. 8 . . . .

FIG. 9 . . . .

FIG. 10 . . . .

### DETAILED DESCRIPTION

Reference will now be made in detail to certain embodiments of the invention, examples of which are illustrated in the accompanying drawings. While the invention will be described in reference to these embodiments, it will be understood that they are not intended to limit the invention. To the contrary, the invention is intended to cover alternatives, modifications, and equivalents that are included within the spirit and scope of the invention. In the following disclosure, specific details are given to provide a thorough understanding of the invention. However, it will be apparent to one skilled in the art that the present invention may be practiced without all of the specific details provided.

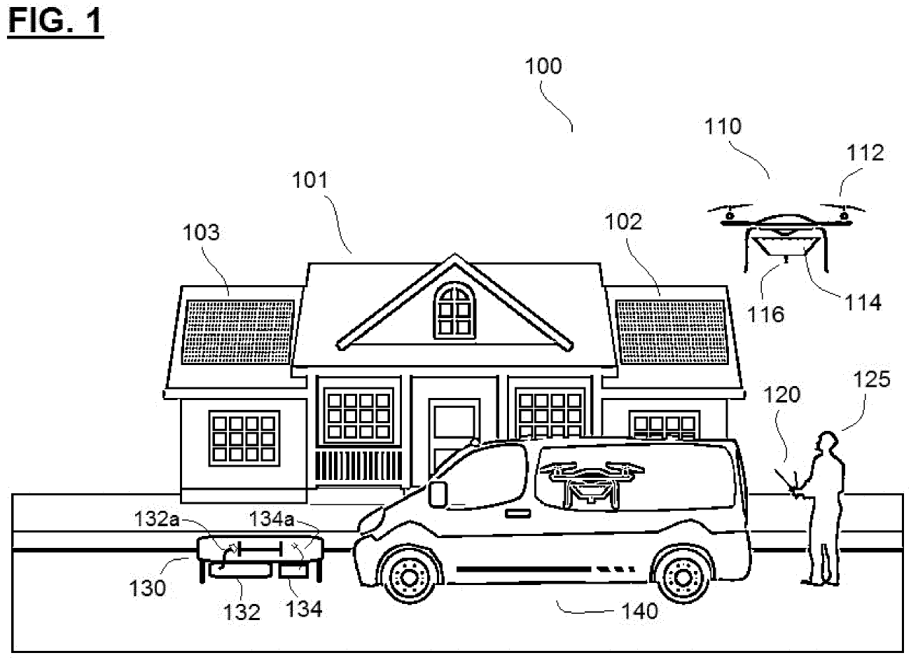

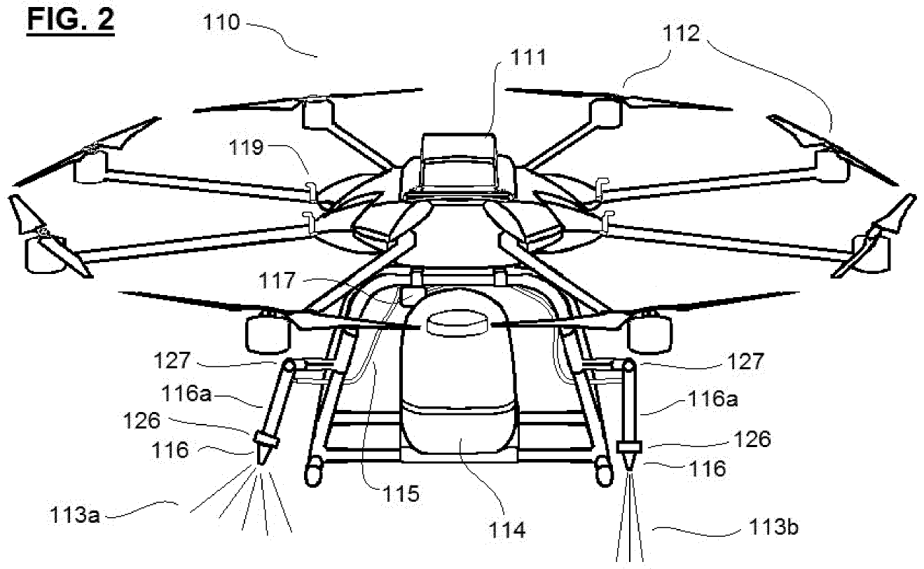

As seen in FIG. 1, the present invention concerns an unmanned aerial vehicle operations system 100 for cleaning one or more designated surfaces 102, 103. At least one of the designated surfaces 102, 103 may be a solar panel installed on a roof of a home. The designated surface may alternatively be a surface of a window, a wall, a roof, an eve, a gutter, a billboard, a scoreboard, a screen, a fence, or another similar surface. As detailed in FIG. 2, the unmanned aerial vehicle (“UAV”) 110 may be a rotor craft such as a multicopter having an onboard controller 111 and plurality of lift devices (e.g., propellers) 112. The UAV 111 may further comprise at least one universal connection docking bay operable to attach any payload having a complimentary payload interface. The onboard controller 111 may be in electronic communication with a wireless communications device for communicating with a remote controller 120. In some embodiments, the onboard controller 111 and/or remote controller 120 may further comprise stereo mapping software operable to utilize UAV sensor data to map out its surroundings. The onboard controller 111 may also be in electronic communication with a GPS device for determining a position of the UAV. The onboard controller 111 may be operable to control the propellers 112, and thus control the flight path of the UAV, which may be operable to easily fly up or over to the position of the designated surface 102, 103 and to apply a spray of cleaning media 113 in order to remove dirt and debris from the surface 102, 103. The cleaning media may be pumped via a pump 117 at high pressure from a tank 114 through a delivery channel 115 (e.g., a watertight line or hose) to at least one distribution device. The distribution device 116 may comprise a nozzle operable to direct a spray of the cleaning media at the designated surface 102/103. The tank 114 may be onboard the UAV 110 such that the UAV 110 may be free to fly in the most direct and efficient flight path and cleaning path 104. The system may thus be operable to safely and efficiently reach and clean one or more designated surfaces 102, 103 in locations which are dangerous, difficult, and time consuming for a human to clean via a ladder or climbing up to the designated surface 102/103.

As seen in FIG. 2, the distribution device 116 may comprise a plurality of adjustable nozzles, and the onboard controller 111 may be operable to adjust a shape, speed, and direction of the spray of cleaning media 113, provided by the plurality of adjustable nozzles 116 via a variety of different methods. For example, the shape and speed of the spray 113 of cleaning media provided by a nozzle of the plurality of adjustable nozzles 116 may be adjusted via a first adjustment device 126 (e.g., an electric motor or a solenoid) operable to twist the nozzle from a first position to a second position with respect to a support member 116a supporting the nozzle. The first position may be operable to provide a wide spray having a relatively slow speed (see 113a), and the second position may be operable to provide a spray having a more acute shape and a relatively higher speed (see 113b). The direction of the spray 113 may be adjusted via a second adjustment device 127 (e.g., an electric motor or a solenoid) operable to rotate the supporting member 116a from a first angle (see 113a) to a second angle (see 113b) about a junction to which the supporting member 116a is attached. In some embodiments, this the distribution device or adjustable nozzles 116 may follow a movement pattern (i.e., side to side, zigzag, etc.) to provide optimal coverage by increasing the coverage of the cleaning media or concentrating it on a particular area. For example, the controller may determine that the surface to be cleaned has a rectangular shape and set the distribution device 116 to follow a side-to-side pattern for optimal coverage of the cleaning media/spray

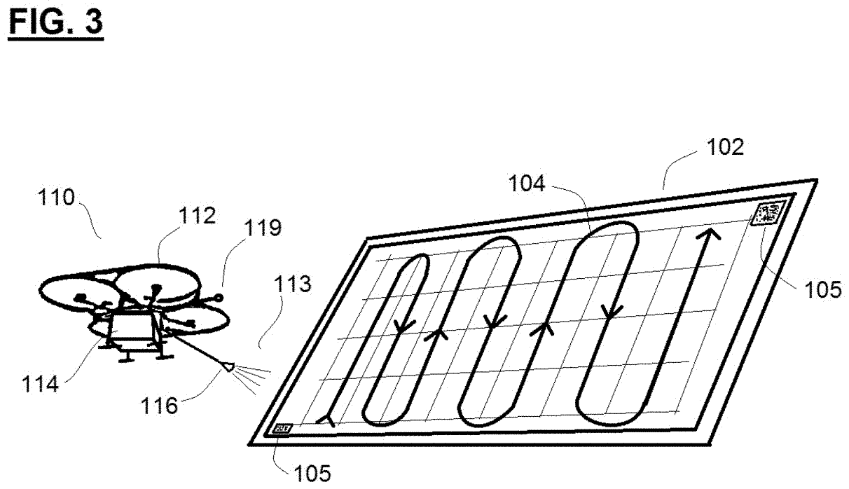

The UAV 110 may also include a sensor suite operable to detect obstacles in the flight path of the UAV 110, as well as the designated surface(s) 102/103 to be cleaned. The sensor suite may include one or more sensors 119 such as a digital camera for capturing images and live video. In some embodiments, as seen in FIG. 3, the sensor 119 may be operable to detect and image a surface marker 105 comprising a code (e.g., a bar code, a QR code, or the like) printed on or adjacent to a designated surface 102, the code either providing data regarding the shape, location, and/or orientation of the designated surface 102, or being associated with such data already stored in the memory of the onboard controller 111. In other embodiments, the controller may further comprise stereo mapping software operable to receive and process at least two images captured by sensor 119 to generate at least one stereoscopic image and utilize the image to approximate the size, shape, and position of nearby objects such as the designated surface 102. The UAV may utilize the approximation of the shape, size, and location of surface 102, as well as information regarding the adjustable nozzle orientation (e.g. spray shape, size, and speed), to generate the most efficient cleaning path 104 to optimize cleaning speed, cleaning media usage, and battery usage. The sensor 119 may thus allow the UAV 110 to determine the exact location, size and shape of the surface 102 to be cleaned, and thus either calculate the most efficient cleaning path 104 for cleaning the surface 102, or progress through a predetermined cleaning path 104 previously recorded in the memory of the onboard controller.

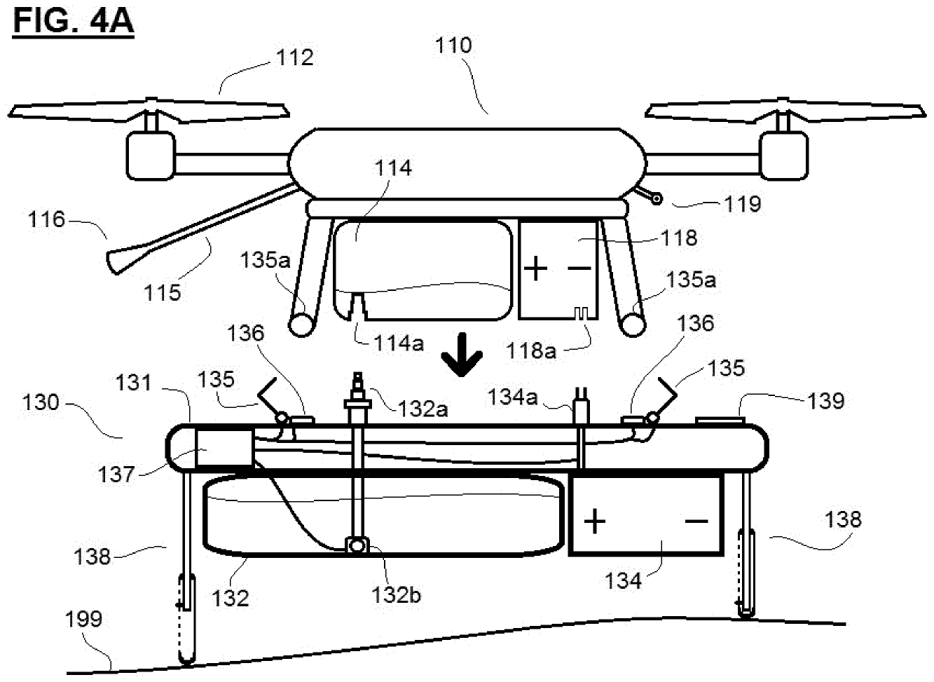

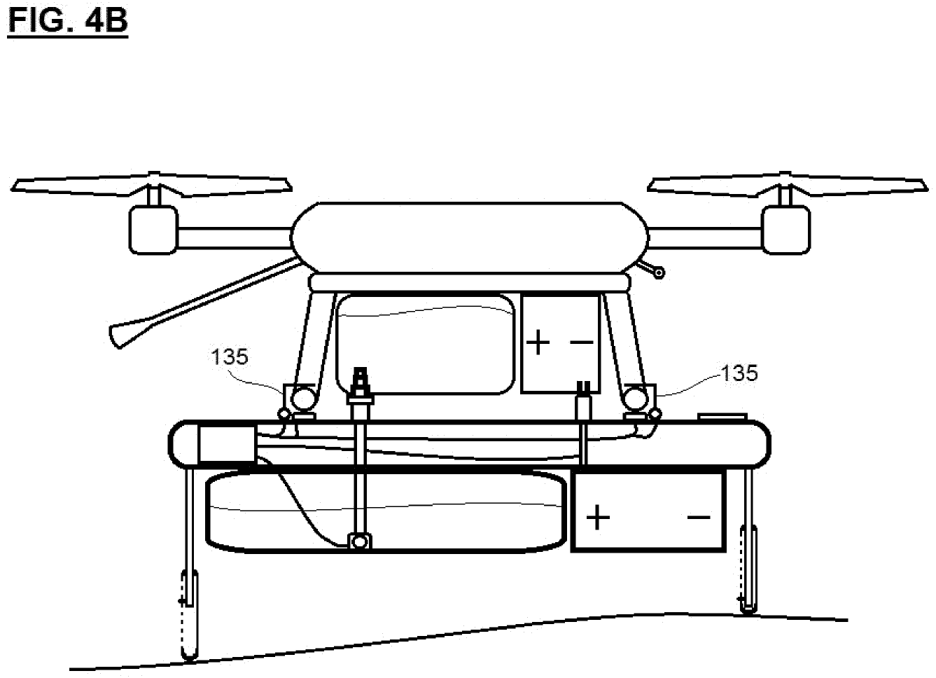

As shown in FIGS. 4A-4B, the system 100 may further comprise a home platform 130 having a substantially flat upper surface 131 of sufficient size for the UAV to safely land upon and be secured to. The home platform 130 may further comprise a reserve tank 132 for holding cleaning media, the reserve tank 132 having a refilling device 132a operable to connect to a fluid receiver of the UAV 110, and a power source 134 for charging a battery of the UAV 110, the power source having a charging device 134a operable to connect to an electrical receiver of the UAV 110. After cleaning a first designated surface 102 the UAV 110 may be operable to make a return trip to the home platform 130 in order to replenish the cleaning media in the tank 114 and/or to recharge before taking off again to clean a second designated surface 103. In some embodiments, the home platform may comprise a series of payloads such as replacement cleaning media tanks, rinsing media tanks, and batteries, each with a payload interface operable to attach the UAV's universal docking bay.

The home platform may include a docking mechanism 135 operable to receive and hold the UAV 110 in place on the upper surface 131, and to line the up the refilling device 132a and the charging device 134a for easy and automatic connection with a refilling receiver 114a and a charging receiver 118a of the UAV battery 118. The refilling device 132a may comprise a quick-connect barbed male hose connector having a shape complementary to a shape of the refilling receiver 114a, which may comprise a quick-connect female hose connector. The charging device 134a may comprise a multi-prong male electrical connector and the charging receiver 118a may comprise a multi-hole female electrical connector.

The docking mechanism 135 may comprise one or more clamping devices arranged on the upper surface 131 the clamping members being operable to fit over and secure lower support members 135a (e.g., landing rails) of the UAV 110. The home platform 130 may comprise one or more docking sensors 136 (e.g., a pressure switches) operable to detect when the lower support members 135a of the UAV are located adjacent to the one or more clamping members 135 and send a docking signal to a home platform controller 137. The clamps of the docking mechanism 135 may then be operable to move from an open position (see FIG. 4A) to a docked position (see FIG. 4B) wherein the clamps hold the lower support members 135a in place on the upper surface 131 and cause the refilling device 132a and charging device 134a to fully engage with the refilling receiver 114a and charging receiver 118a, respectively. The docking sensors 136, the clamping mechanism 135, the charging device 132a, and the pump 132b of the reserve tank 132 may each be in electronic communication with and/or controlled by the home platform controller 137, the home platform controller 137 being operable to receive the docking signal from the docking sensors 136 and subsequently: 1) cause the docking mechanism 135 to move from the open position to the docked position; 2) activate the pump 132b to pump cleaning media from the reserve tank 132 to the tank 114 onboard the UAV 110 and shut the pump 132b off when the onboard tank 114 is substantially full or the reserve tank 132 is substantially empty; and 3) cause the power source 134 to charge the battery 118 of the UAV 110 the until the battery 118 is substantially charged or the power source 134 is substantially out of power. The home platform controller 137 may further be operable to automatically cause the docking mechanism 135 to move back to the open position at the occurrence of at least one (or both) of the onboard tank 114 becoming substantially full with cleaning media and the battery 118 obtaining a full charge.

The home platform 130 may further comprise a platform marker 139 on the upper surface 131, the platform marker 139 comprising a code readable by the one or more sensors 119 of the UAV 110, and deciphered by the onboard controller, the code providing information regarding a position and orientation of the upper surface 131 of the home platform 130 such that the UAV 110 may determine exactly where to lower itself in order to dock. The onboard controller may thus be able to determine exactly how to orient the UAV 110 (e.g., how many degrees to rotate left or right) and how far to travel (e.g., exactly 12 inches away from the corner of the platform marker) in order to sufficiently align the lower support members 135a with the docking mechanism 135 such that the UAV 110 may automatically dock with the home platform 130.

The home platform 130 may further comprise leveling means allowing a user to adjust the position of the home platform 130 such that the upper surface 131 is level (e.g., a plane of the upper surface 131 is substantially perpendicular to vertical). The leveling means may comprise a plurality of extendable legs 138, each having a first and second member slidably engaged with each other and lockable with respect to each other. For each of the plurality of extendable legs 138, the first cylindrical member may be slidably nested within the second cylindrical member, the first cylindrical member comprising a resilient depressible tab and the second cylindrical member comprising a series of slots along a length thereof in which the depressible tab may be inserted). Each extendable leg of the plurality of extendable legs 138 may thus be independently adjusted in length to conform to uneven ground 199 until the home platform 130 is level.

As shown in FIG. 1, the system 100 may further comprise a remote controller 120 operated by a UAV pilot 125 for remotely controlling the UAV 110 and the distribution device 116 and a transport vehicle 140 for transporting the UAV 110 and the home platform 130 to a location adjacent to the designated surfaces 102, 103.

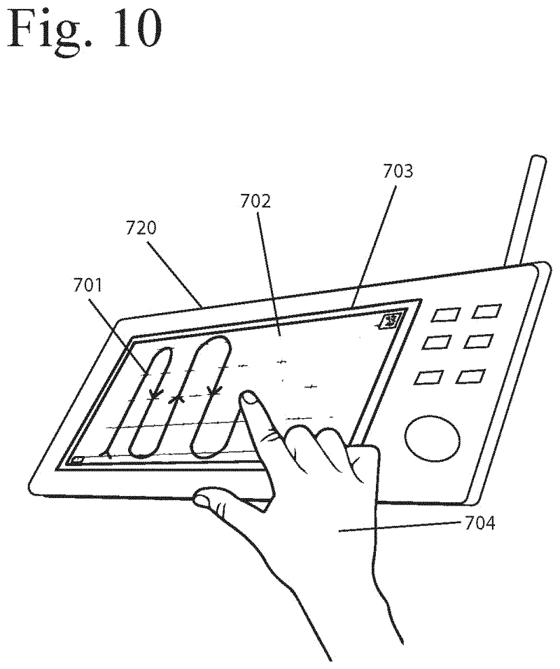

In some embodiments, as shown in FIG. 10, the remote controller 720 may contain augmented reality technology, or technology that superimposes a computer-generated image(s) on the feed of at least one camera, that may be utilized in combination with data provided by the UAV sensor suite to provide an ease-of-use piloting method on the remote controller screen 720. The screen, hereinafter referred to as the augmented display 703, may be a touchscreen on the remote controller 720 that displays an augmented reality environment wherein one or more augmentations 701 overlays the video feed 702 that enable the pilot to easily monitor and/or control the UAV 110. Such augmentations 701 provided on the screen may include information regarding the UAV's components or flight characteristics such as flight path, altitude, battery level, cleaning media level, distance from an object, speed, angle, rotation, distribution device head, adjustable nozzle head, and direction of the distribution device. Such augmentations may include methods of adjusting the UAV's 110 components and flight characteristics such as by adjusting dials/knobs, buttons, graphical control features presented on the display screen, or by interacting with remote objects displayed on the video feed, such as solar panels.

Augmentations 701, may comprise a visual emphasis rendered on zones and/or objects in the video feed that the controller or pilot have determined to be important, and may allow the pilot to interact with them to control the UAV in a particular way. For example, as shown in FIG. 10, the pilot may see a solar panel on the video feed 702 and draw out a cleaning path that is represented by augmentation 701 (a black line with arrows) and based on drawings generated by touch input from the pilot's hand on the display 703. The visual emphasis may comprise highlighting, shapes, coloring, shading, bounding or any other practical form of visual emphasis. Zones and objects of interests in the video feed may include any of the following: the projection of a recorded flight path, the projection of a calculated flight path, one or more surfaces to be cleaned, the projection of an application/spray area of cleaning media on a surface, a mobile vehicle, a building, and obstacles. In some embodiments, if the flight path has already been recorded or determined, the projected flight path may be highlighted on the video feed provided on the augmented display, wherein the highlighted portion is adjusted dynamically as the UAV travels through the path. In such embodiments, the flight path may be adjusted via touch input received on the augmented display. For example, the user may simply draw on the augmented display or tap on a designated object to erase, adjust, or create a new flight path for the UAV. In some embodiments the augmented display may be able to display a map of the local area and allow the pilot to create a flight path by drawing the path on the map.

In some embodiments the remote controller may detect a remote surface, determine its distance from the UAV, and highlight the area of the augmented display pertaining to the remote surface wherein the application of cleaning media will reach, hereinafter referred to as the spray area. In such embodiments, the augmented display may allow the user to preview the spray area of various heads of the adjustable nozzle or distribution device. For example, the augmented display may shade areas on the surface covered by a wide nozzle spray in red and a narrow nozzle spray in blue, wherein the overlap is purple. In some embodiments, the augmented display may also preview the effective spray area of a distribution device that's following a movement pattern. For example, if the distribution device is following a side-to-side pattern, the augmented display may preview the effective spray area after one cycle by displaying lines bounding the area on the video feed. In some embodiments the augmented display may preview the entire spray area on a surface for a surface cleaning path, hereinafter referred to as spray path. For example, the UAV may approach a solar panel, retrieve path information from its memory, and direct the augmented display to shade the spray path in blue. In some embodiments, the augmented display may enable the pilot to adjust or create a new spray path by interacting with it on the display. For example, if new solar panels were added to a location since the previous cleaning, the pilot may simply draw on the display where the new panels are visible to add on to the spray path. In some embodiments, when the distribution device heads, the adjustable nozzle head/position, or movement pattern is altered, the UAV controller may automatically adjust the cleaning path and/or movement pattern to generate a spray path that's most similar to the previous spray path. For example, if a cleaning path was previously recorded for a wide spray nozzle and the pilot decides to adjust it to a narrow spray nozzle, the UAV controller may determine a new cleaning path that provides similar or identical coverage as the previous spray path.

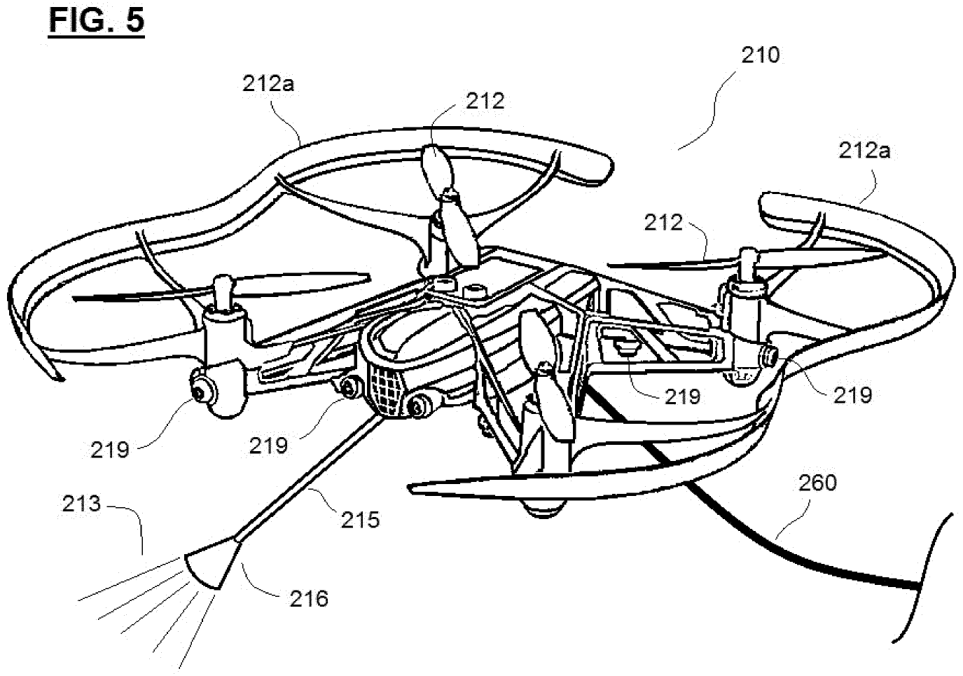

In another embodiment, as seen in FIG. 5, the cleaning media may be pumped up to the UAV 210 via a tether 260, through the delivery channel 215, and out to the distribution device 216, which may be a showerhead, while the UAV 210 runs the showerhead 216 over the designated surface 102/103. The UAV 210 may comprise four propellers 212, each propeller 212 being protected from contacting adjacent objects (e.g., branches, walls, poles, gutters, and people) via a barrier 212a, preventing both injuries, damage, and loss of lift for the UAV 210. The UAV may further comprise a plurality of sensors 219 (e.g., digital cameras and/or motion sensors) for determining the position of the UAV 210 and the adjacent objects, and viewing the area adjacent to the distribution device 216 to scan for and recognize the position of the designated surface 102/103, and to ensure that the designated surface 102/103 is being sufficiently cleaned.

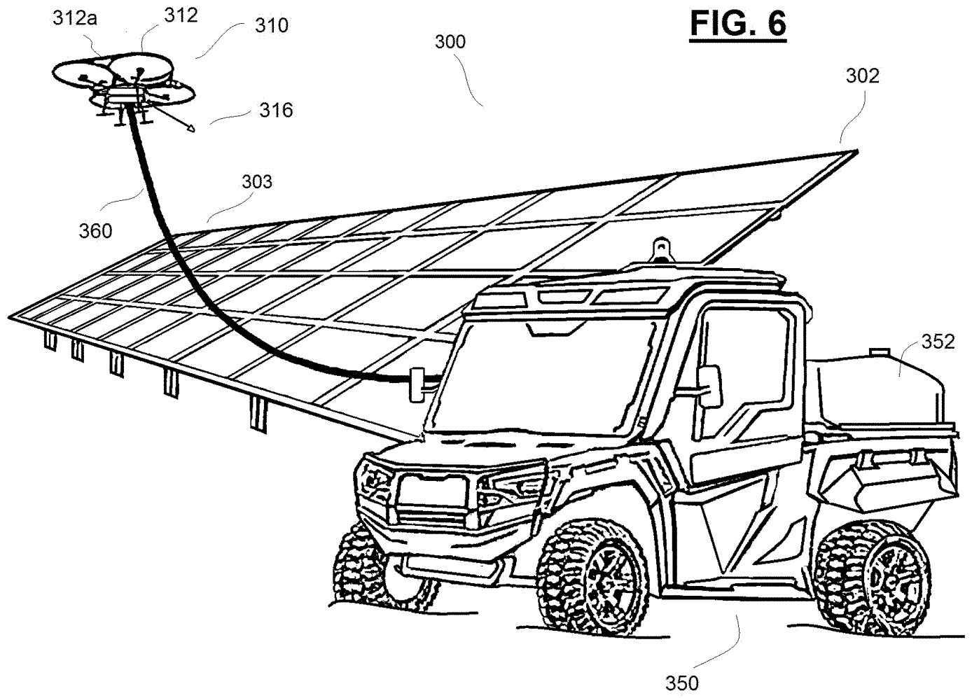

FIG. 6 shows a perspective view of an embodiment of the system 300 comprising a UAV 310 having a plurality of propellers 312 protected by a barrier 312a, and a distribution device 316 comprising a nozzle, the nozzle 316 operable to direct a spray of cleaning media at a surface 302 of a solar panel installed in a row at a solar farm. The cleaning media is pumped up to the UAV 310 via a tether 360 which is in fluid communication with a tank 352 of a ground companion vehicle 350. The tether 360 may further comprise an electrical lead operable to provide electrical power to the UAV 310 or a battery thereof. The ground companion vehicle 350 may be operable to follow a path on the ground which approximates a flight path of the UAV 310, providing both cleaning media and power to the UAV 310 and enabling the UAV 310 to clean a plurality of designated surfaces of the row of solar panels, from a surface 302 of a first solar panel to a surface 303 of a last solar panel, without the need to make a return trip to refill or recharge.

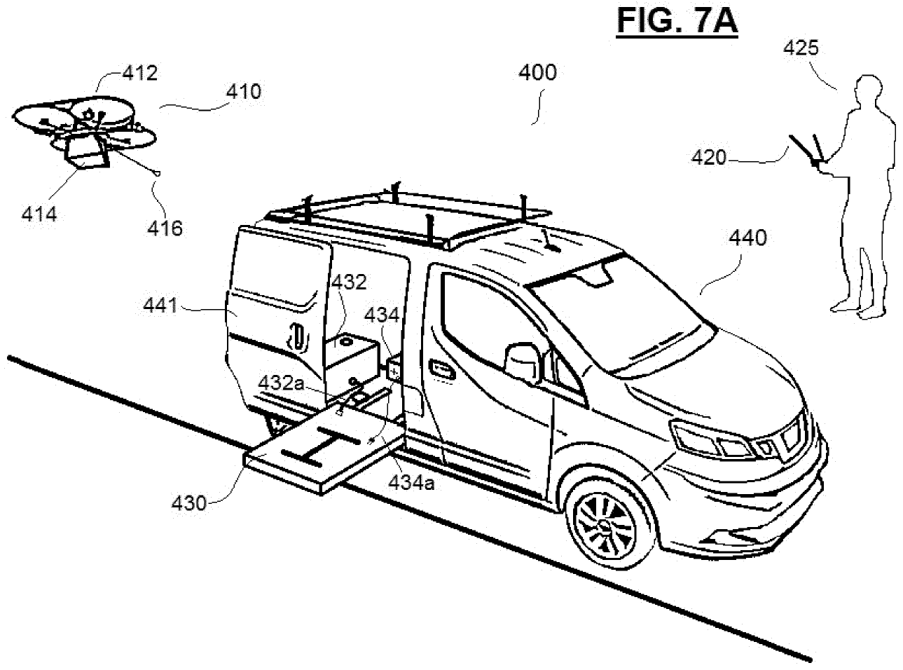

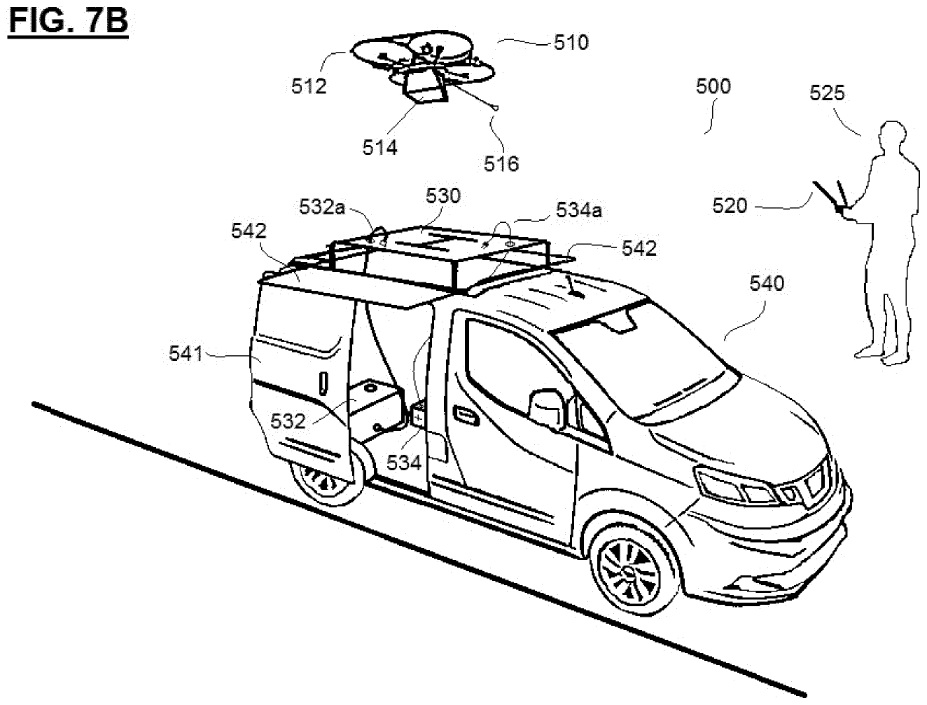

As seen in FIG. 7A, in another embodiment of the present invention 400, a home platform 430 may be installed on or in a transport vehicle 440 (e.g., mounted to the transport vehicle 440 on rails which allow the home platform 460 to be pulled out of an open side door 441 of the transport vehicle). The transport vehicle may comprise a reserve tank 432 for holding cleaning media and having the refilling device 432a for refilling the onboard tank 414 of the UAV 410, and a power source 434 having a charging device 434a for charging a battery of the UAV 410. The reserve tank 432 and the power source 434, may be installed anywhere in or on the transport vehicle 440 (e.g., in a cargo bay). FIG. 7B shows another embodiment of the present invention 500, wherein the transport vehicle comprises a side door 541 for access to the cargo area, and a top-hatch door 542 allowing the home platform 530 to extend up through the roof of the vehicle.

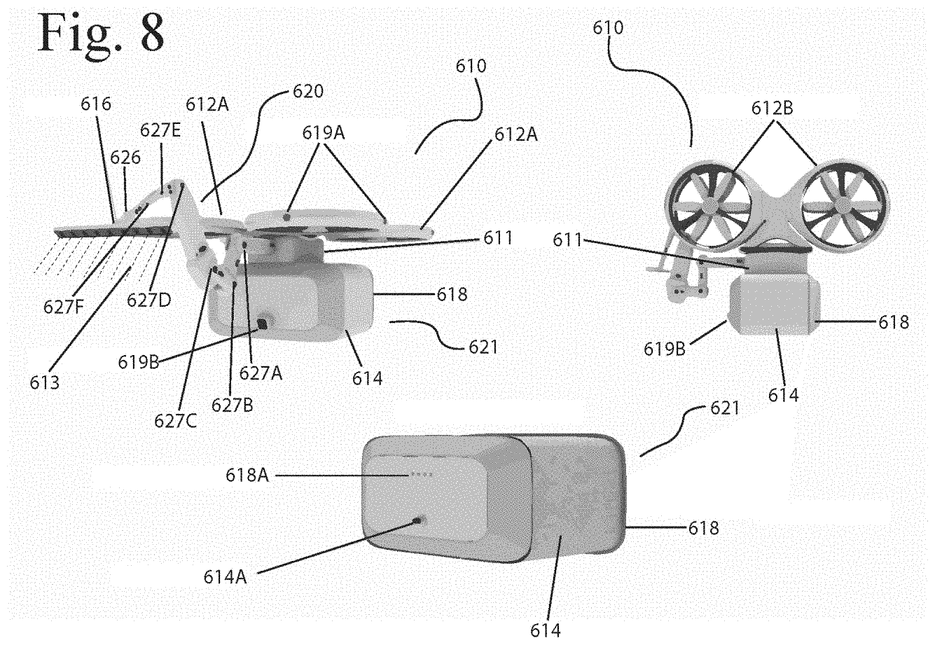

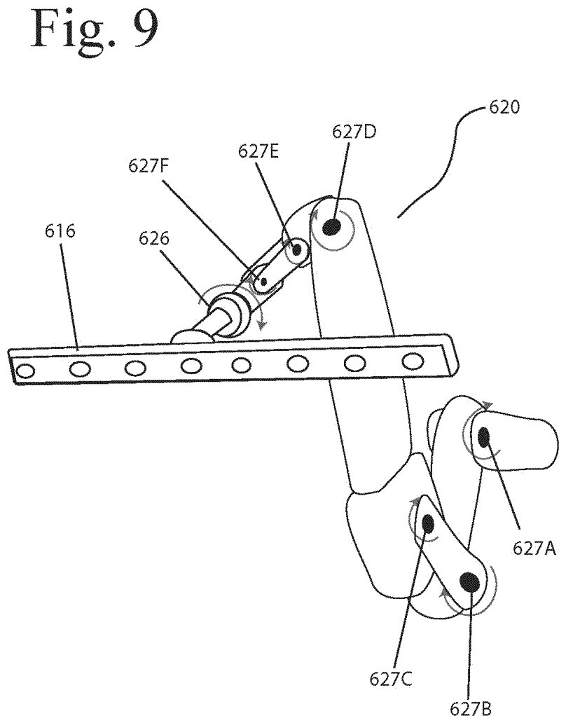

In another embodiment, as seen in FIG. 8 and FIG. 9, the present invention may comprise the supporting member 620, distribution device 616, lift devices 612, controller 611, storage unit 621, and various sensors 619. The supporting member 620 may function as an extendable arm with a plurality of rotatable joints 627 (A-F) that enable the supporting member to retract, extend, lower, and/or raise the distribution device 626. The plurality of rotatable joints 627 provide the distribution device of the UAV with a wide coverage and a variety of spray patterns/motions such as a sweeping or mopping pattern. The distribution device 616 may comprise a panel with an array of adjustable nozzles, and the onboard controller 611 may be operable to adjust the shape, speed, and direction of the spray 613 of cleaning media, provided by the plurality of adjustable nozzles. The shape and speed of the spray 613 of cleaning media may be controlled by adjusting one or more nozzles in the array of adjustable nozzles. For example, the adjustable nozzle may be adjusted in orientation to decrease the size of the nozzle opening, therefore increasing the pressure at the nozzle output for a spray with a higher velocity/pressure. The support member may further comprise adjustment member 626, operable to change the direction of the spray 613 by rotating and/or tilting the distribution device 616. For example, the UAV may shift from the orientation shown in FIG. 8, wherein the distribution device 616 is oriented horizontally the and aimed downwards via the supporting member 620, to an orientation wherein the distribution device 616 is oriented vertically via the adjustment member 626. The lift devices 612 may comprise a plurality of propellers operable to alternate from a deployed orientation 612A to a withdrawn orientation 612B. Each lift device 612 may be further operable to maintain any angle between 0° and 90° to improve maneuverability of the UAV, wherein the a deployed orientation 612A corresponds with a 0° angle and a withdrawn orientation corresponds with a 90° angle. For example, the UAV may detect steady winds coming from the UAV's right side shifting the UAV and utilize the feedback system to counter the force of the wind by adjusting the UAV's two right propeller 612 to an angle (e.g., 30°) that counteracts the force sufficiently to prevent such shifting.

Such embodiments may comprise a plurality of sensors 619, including plurality of navigation sensors 619A and at least one camera 619B each located in a predetermined location to optimize drone piloting. For example, a plurality of navigation sensors equally spaced upon the shield of each propeller/lift device 612. In such example, the navigation sensors 619A may comprise cameras and may be placed in a predetermined manner such that the UAV may use stereo mapping software to approximate the size, shape and location of the surrounding objects within a 360° FOV and 10 meter range (including the surface that needs to be cleaned). In another embodiment, the navigation sensors 619A comprises proximity sensors, operable to detect any object within the sensors range to enable the UAV to avoid obstacles. At least one camera 619B may be located proximal to the support member 620 so that the effective spray area is within the field of view of the camera. For example, in such embodiments, the camera 619B may be located under the support member, on the storage unit 621. The storage unit 621 may house the cleaning media tank 614 as well as the UAV battery 618 and further comprise a refilling receiver 614A and a charging receiver 618A. In some embodiments, at least one camera 619B and/or the navigation sensors may be used in conjunction with the stereo mapping software to provide video feed and/or data to an augmented display on a remote controller. In some embodiments, the controller 611 may be located at the center of all the devices such that it may directly interface, monitor, and/or control all parts of the UAV, such as the support member, the plurality of sensors, distribution device, battery, cleaning media tank, charging receiver, refilling receiver, and the plurality of lift devices.

The foregoing descriptions of specific embodiments of the present invention have been presented for purposes of illustration and description. They are not intended to be exhaustive or to limit the invention to the precise forms disclosed, and many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated.

1. A system for cleaning a designated surface, the system comprising:
a. an unmanned aerial vehicle, said aerial vehicle including:
i. at least one sensor operable to detect the position and outline of said surface;
ii. an onboard controller having a memory and a communications device; and
iii. at least one distribution device for applying a cleaning media to said surface.

2. The system of claim 1, wherein said unmanned aerial vehicle comprises a drone having a battery, a plurality of lift devices, an onboard tank for holding a cleaning media, and a pump for pumping said cleaning media through a delivery channel, said delivery channel putting said onboard tank in fluid communication with said distribution device.

3. The system of claim 2, wherein said onboard controller is operable to determine positioning data regarding a surface cleaning path of said drone, said positioning data being based on a scan of a shape and size of said surface via said at least one sensor, and a GPS position of said surface, said memory being operable to store said positioning data, and said onboard controller being operable to automatically navigate said drone through said surface cleaning path for subsequent cleaning(s) of said surface.

4. The system of claim 3, further comprising a feedback system operable to receive and process said positioning data to enable said controller to continuously adjust said plurality of lift devices to maintain at least one flight characteristic, wherein the propulsion velocity and/or angle of each lift device of said plurality of lift devices as well as the orientation of said distribution device are operable to be continuously adjusted due to input provided by said feedback system to said controller.

5. (canceled)

6. The system of claim 4, wherein said at least one sensor comprises at least one camera and said controller further comprises stereo mapping software operable to generate said positional data by identifying objects and approximating their size, shape, and position within said at least one camera's field of view.

7. The system of claim 6, wherein said at least one sensor further comprising:
a. a gyroscope sensor operable to determine the rate of rotation, angular velocity and tilt of said unmanned aerial vehicle, and
b. an accelerometer operable to monitor the acceleration of the drone along at least one axis, wherein said feedback system is operable to detect environmental factors that affect flight characteristics, including high wind speeds, periodic gusts of wind, precipitation, atmospheric particles, and physical obstacles.

8. (canceled)

9. The system of claim 4, wherein said flight characteristic is chosen in order to optimize consumption of at least one resource.

10. The system of claim 5, wherein said at least one resource comprises service time, said cleaning media usage, and battery power.

11. The system of claim 4, wherein said flight characteristics comprise flight path, cleaning path, spray path, distribution device, orientation of the distribution device, field of view of said at least one sensor, altitude, tilt angle, distance from surface and movement pattern.

12. The system of claim 3, wherein said at least one sensor comprises at least one camera and said controller further comprises stereo mapping software operable to generate said positional data by identifying objects and approximating their size, shape, and position within said at least one camera's field of view and further comprising a remote controller operable to communicate with said unmanned aerial vehicle to receive said positioning data and live video feed from said at least one camera and remotely control said unmanned aerial vehicle.

13. The system of claim 12, wherein said remote controller further comprises an augmented display with touch controls and operable to display said positioning data, live video feed, and augmentations on said video feed that provide a visual emphasis on objects and zones of interest that are viewable on said live video feed and enable a user to pilot said unmanned aerial vehicle by drawing and selecting augmentations or objects on the display.

14. The system of claim 2, wherein said distribution device is operable to spray cleaning media further comprises:
a. at least one adjustable nozzle operable to adjust the shape, speed, and direction of the spray,
b. a supporting member comprising a plurality of rotatable joints that enable said distribution device to be retracted, extended, lowered, raised, and directed by the rotation of said rotatable joints, and
c. an adjustment member operable to rotate said distribution device therefore enhancing its maneuverability and range.

15. The system of claim 2, wherein said unmanned aerial vehicle further comprises a universal docking bay operable to attach at least one payload having a payload interface, enabling said unmanned aerial vehicle to perform services requiring dusting/spraying, transportation of a payload, and monitoring.

16. The system of claim 13, wherein said universal docking bay is further operable to make an electrical connection with the payload having electrical connections for power and/or data, and a fluid connection for payloads having cleaning media, rinsing media, or other fluids

17. The system of claim 14, wherein the contents of said payload comprise pressurized air, fumigants, fertilizer, pesticide, a package, or additional sensors, enabling said unmanned aerial drone to perform parcel delivery, crop dusting, irrigation, fumigation, and/or surveillance services.

18. (canceled)

19. The system of claim 12, wherein said adjustable nozzle further comprises an adjusting mechanism for alternating said adjustable nozzle between a plurality of positions wherein each position corresponds to a different spray type.

20. The system of claim 4, wherein at least one flight characteristic comprises the distance between said unmanned aerial vehicle and said surface.

21. The system of claim 13, wherein said objects and zones of interest include the projection of a flight path, said surface, the projection of the application of said cleaning media on said surface, a mobile vehicle, buildings, and obstacles.

22. The system of claim 21, wherein said augmented display is operable to enable a user to control said unmanned aerial vehicle by utilizing said touch controls to interact with and create said augmentations.

23. The system of claim 22, wherein said remote controller is operable to calculate a flight path based on a path drawn on said live video feed by said user and display it as an augmentation on said augmented display.

24. (canceled)
